(19) United States
(12) Patent Application Publication
(10) Pub. No.: US 2009/0157887 A1
(43) Pub. Date: Jun. 18, 2009

(54) Control for the interface for sending an SIP reply message

(75) Inventors: Thomas Froment, Longpont Sur Orge (FR); Christophe Lebel, Haute Goulaine (FR)

Correspondence Address: HARNESS, DICKEY & PIERCE, P.L.C., P.O. BOX 8910, RESTON, VA, 20195, US

(73) Assignee: ALCATEL LUCENT

(21) Appl. No.: 12/289,738

(22) Filed: Nov. 3, 2008

(30) Foreign Application Priority Data
Dec. 18, 2007 (FR) FR 0759927

(51) Int. Cl. G06F 15/16

(52) U.S. Cl. 709/228

(57) ABSTRACT

In one embodiment a communication client, includes at least one sending interface to send a signaling message in accordance with the SIP protocol, towards a first interface of a communication server. The client and server are connected by a communication network. The communication client is suitable for inserting an indication within the signaling message regarding the interface for the communication server to use to send its response signaling message.

This invention relates to signaling enabling the establishment of multimedia sessions on a data communication network. More particularly, it pertains to the SIP (Session Invitation Protocol) protocol defined by RFC 3261 of the IETF (Internet Engineering Task Force).

FIG. 1 depicts a simplified architecture implementing the SIP protocol. Two communication elements, C and S, such as terminals, are connected to one another via a communication network N. They may be connected to intermediary communication elements, known as P_{C} and P_{S}.

Assume that element C wants to establish a communication session with communication element S. To do so, it transmits a signaling message m to a proxy server P_{C} to which it is connected. This first message is typically an “Invite” SIP message.

It may then be transmitted by a series of intermediary elements, not depicted in the figure, before reaching the intermediary element P_{S} to which the communication element S is connected. The signaling message m is then delivered to that recipient element S.

The first communication element C is known as the “client” and the second the “server”, but these are functional terms, i.e. roles which the communication elements may take on, depending on the circumstances. The client is the element which is sending a signaling message to a server, and awaits a response from it.

The communication clients and servers may be communication terminals, as in the example of FIG. 1, but they may also be application servers or signaling servers, such as servers implementing CSCF (“Call Session Control Function”) functions within an IMS (“IP Multimedia Subsystem”) architecture.

An SIP signaling message comprises multiple headers to ensure its being routed within the communication network, as well as information enabling the parties to establish the multimedia sessions.

Among these headers are headers which indicate the sending and recipient interfaces of the signaling message.

“Interface” refers to a pair formed by an IP address (IPv4 or IPv6) and a port number. A single communication element may have multiple interfaces. It may have multiple IP addresses, if it belongs to multiple communication networks.

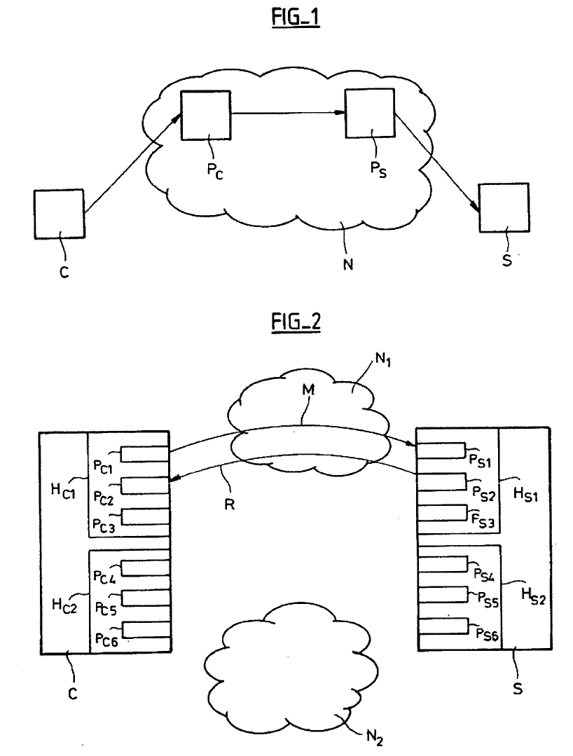

FIG. 2 depicts a diagram of this situation. The two communication elements C and S are connected via two communication networks N₁ and N₂. The client C therefore has two IP addresses, H_{C1} and H_{C2}, respectively used for networks N₁ and N₂. Likewise, the server has two IP addresses, H_{S1} and H_{S2} respectively used for networks N₁ and N₂.

Each of these elements has multiple ports: client C includes ports P_{C1}, P_{C2}, P_{C3}, P_{C4}, P_{C5}, P_{C6}, and server S includes ports P_{S1}, P_{S2}, P_{S3}, P_{S4}, P_{S5}, P_{S6}

Whenever the client C sends a signaling message M, it indicates an identifier of the server S in the header. This identifier may be a logic address that will be translated by an intermediary element, or may directly be an address or physical interface (i.e. the port may or may not be specified). It also indicates the interface from which it sends the message, as well as the interface where it wishes to receive a response. These two interfaces may be the same or different.

In the example of FIG. 2, the signaling message M is transmitted from the interface H_{C1}/P_{C2} to the interface H_{S1}/P_{S2} and specifies that the response is desired to reach the interface H_{C1}/P_{C3}. The server S responds with a response signaling message R, sent from the interface H_{S1}/P_{S3} to be received by the desired interface H_{C1}/P_{C3}.

However, the client C may not specify the interface from which it wishes to have the server send it the reply message R. The way by which it determines which output interface to use depends on the implementation.

However, it may prove necessary, under some circumstances, to use one interfaces rather than another. For example, this is true if a NAT (for “Network Address Translation”) address translation device is placed between the client C and the server S, or if a secure communication protocol such as IPsec is used to transport signaling messages.

There is therefore a need to offer the communication client a mechanism for checking the determination of which interface the server is to use to reply to a signaling message.

The purpose of the invention is to address this lack.

The first object of the invention is a communication client comprising at least one sending interface for sending a signaling message, in accordance with the SIP protocol, to a first interface of a communication server. The client and server are connected by a communication network. The inventive client is characterized in that it is suitable for inserting an indication into the signaling message regarding the interface to be used by the communication server to send its reply signaling message.

In one embodiment of the invention, the indication contains an address to be used by the communication server to send its reply signaling message.

This indication may also contain a reserved word specifying behavior for the communication server to comply with when choosing the address to use for sending its reply signaling message.

This reserved word may be chosen from among a group comprising at least:

a reserved word specifying that the address to use is the same as that of the first interface;

a reserved word specifying that the address to use must be determined randomly;

a reserved word indicating a semantic criterion for determining the address to use.

The indication may further contain a port number for the communication server to use for sending its reply signaling message.

This indication may also contain a reserved word specifying behavior for the communication server to comply with when choosing the port number to use for sending its reply signaling message.

This reserved word may be chosen from among a group comprising at least:

a reserved word specifying that the port number to be used is the same as that of the first interface;

a reserved word specifying that the port number to use must be determined randomly;

a reserved word indicating a semantic criterion for determining the port number to use.

Likewise, a problem arises with respect to enabling the communication client to check the determination of the transport protocol used by the server to reply to a signaling message.

The communication client may be designed to insert a second indication regarding the protocol for the server to use for sending its reply signaling message.

This second indication may be transmitted in addition to the interface-related indication, or alone.

The indication and/or the second indication may, for example, be inserted into a “Via” header.

Another object of the invention is a communication server comprising at least one interface for receiving an incoming signaling message from a communication network, and a second interface for sending a reply signaling message.

The server is characterized in that it is further designed to determine the second interface based on an indication contained within the incoming signaling message.

The indication may contain an address corresponding to the second interface or a reserved word specifying a behavior to carry out for choosing the address corresponding to the second interface.

In the latter case, the reserved word may be chosen from among a group comprising at least:

a reserved word specifying that the address is the same as that of the first interface;

a reserved word specifying that the address must be determined randomly;

a reserved word indicating a semantic criterion for determining the address.

The indication may also contain a port number corresponding to that second interface.

It may contain a reserved word specifying a behavior to carry out for choosing the port number corresponding to the second interface.

This reserved word may be chosen from among a group comprising at least:

a reserved word specifying that the port number is the same as that of the first interface;

a reserved word specifying that the port number must be determined randomly;

a reserved word indicating a semantic criterion for determining the port number.

The server may further be designed to determine the protocol to use for sending the reply signaling message, based on a second indication contained within the incoming signaling message.

The indication and/or the second indication may be inserted into a “Via” header.

Another object of the invention is a method for the communication of signaling messages between a client and a server connected by a communication network, comprising a first step of the client transmitting a signaling message to the server, and a second step of this server transmitting a reply message to that client, from an interface.

The method is characterized in that the client inserts an indication within the signaling message prior to the first step, and in that the server determines the interface based on this indication, prior to said second step.

Another object of the invention is a communication terminal designed to implement a communication client or communication server as previously described.

Another object of the invention is a communication network comprising at least one such terminal.

The communication server and/or the communication client may be an element implementing a CSCF function in accordance with the specifications of an IMS architecture.

Another object of the invention is a communication device designed so that when it receives an incoming signaling message carried by the TCP protocol and intended for a second communication device located behind an address translation device, it transmits to that second device a signaling message using the UDP protocol and containing an indication specifying that the second device must transmit a reply to the communication device using the TCP protocol, and transmit this incoming signaling message after the receipt of the reply message.

It should be noted that this addition of an indication remains entirely compatible with the SIP protocol as defined by the RFC 3261. It is also compatible with the extensions to the SIP protocol defined by RFC 3581 entitled “An extension to the Session Initiation Protocol (SIP) for Symmetric Response Routing”. This RFC defines additional parameters, “received” and “rport” related to the interface used by the server to receive the signaling message. They are therefore parameters distinct from the indication regarding the interface for the server to use. This indication and the parameters of RFC 3581 may coexist within a signaling message, or may be used separately.

The invention and its advantages will become more clearly apparent in the following description, with reference to the attached figures.

The above-mentioned FIG. 1 depicts a simplified architecture which brings a communication server and client into communication with one another.

FIG. 2, also mentioned above, depicts communication between a client and a server, each having multiple communication interfaces.

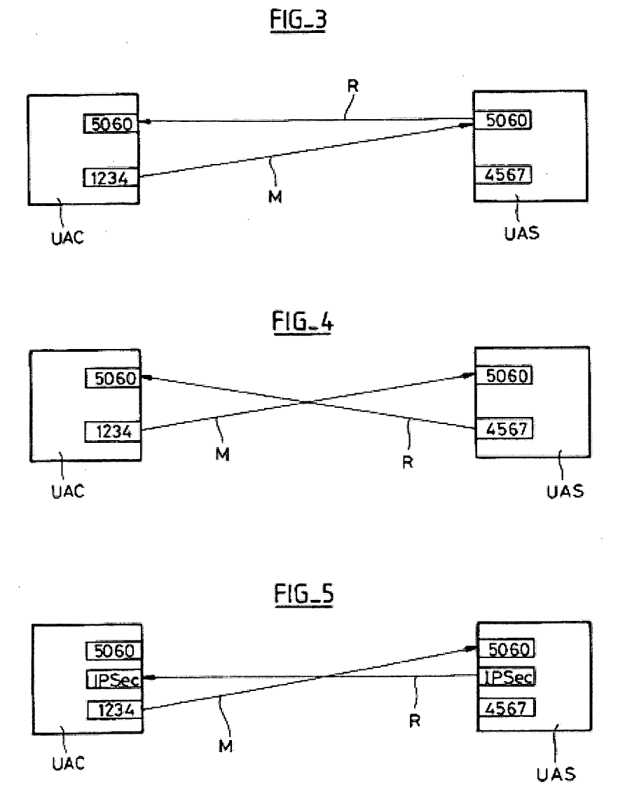

FIGS. 3 to 5 depict three applications of the inventive mechanism.

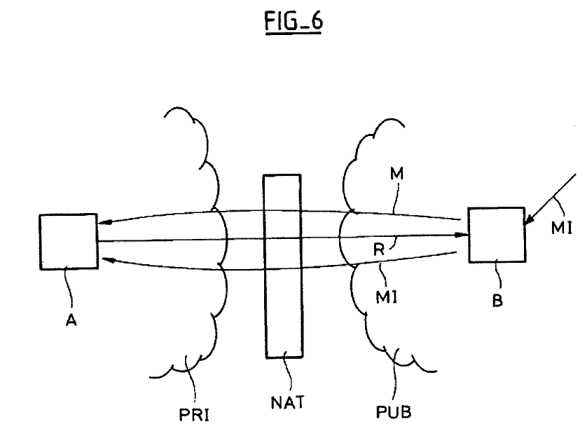

FIG. 6 depicts the use of the inventive method for the problem of address translation device traversal.

A signaling message that complies with the SIP protocol contains multiple headers.

The “From”, “To”, and “Contact” headers relate to the elements sending and receiving the signaling message. In the example depicted in FIG. 1, assume that the sending element is the client C and the receiving element is the element S.

Each intermediary element, such as the proxy servers P_{C} and P_{S}, adds a “Via” header to the retransmitted signaling message.

This “Via” header thereby makes it possible to mark the path taken by a signaling message within a network. A reply message may then take the same path, in the reverse direction, using the “Via” headers. Each intermediary element crossed in this manner removes the “Via” header that pertains to itself.

In FIG. 2, the communication client C is the sender of the signaling message M. It may, for example, be a communication terminal or, more generally, a UAC (“User Agent Client”), or an application server, etc.

It may also be an “SIP proxy” intermediary element.

Likewise, the communication server S may be the recipient of the signaling message, and may be a terminal, an application server, a signaling server, etc.

It may also play the role of an “SIP proxy” intermediary element.

For an IMS (“IP Multimedia Subsystem”), architecture, these communication elements may be signaling elements implementing a CSCF (“Call Session Control Function”) function.

As a reminder, the terms “client” and “server” are used in the context of sending a signaling message. The same communication element may play the roles of both client and server. For example, a terminal may be a client when it sends an invitation message to initiate a communication session with another party, then become a server when it receives an invitation message from another terminal.

These definitions comply with paragraph 6 of the IETF's RFC 3261.

The communication client C comprises at least one sending interface for sending a signaling message M to a server S, over a communication network N₁.

When the client C sends the signaling message M, it inserts a “VIA” header. If it is not the sender of the message, but rather is acting as an intermediary element, it adds this header to the list of “Via” headers already present.

This header indicates the transport protocol used for transmitting the message, and identifies the interface where the client wishes to receive a reply.

This “Via” header comprises multiple parameters, some of which are mandatory and others optional.

Based on the example given by RFC 3261, a “Via” header may be of the following form:

Via: SIP/2.0/UDP erlang.bell-telephone.com:5060;

branch=z9hG4bKa7c6a8dlze;

The “erlang.bell-telephone.com:5060” parameters respectively represent the address of the client C and the port where it wishes to receive the reply. The parameters “SIP/2.0/UDP” respectively determining the version of the SIP protocol used and the transport protocol used t transmit the signaling message between the client and the server.

In the example of FIG. 2, such a “Via” header may have the value:

Via: SIP/2.0/UDP H_{C1}:P_{C3}; branch=z9hG4bKa7c6a8dlze;

In accordance with the invention, the client may further be designed to insert an indication regarding the interface for the server (i.e. the network element receiving the signaling message) to use for sending its reply signaling message.

This interface may be determined by a port, when the server possesses only one IP address, or by an IP address/port pair, when it has multiple IP addresses.

Consequently, the indication may be made up of one or two parts: one regarding the IP address (“network interface”), and the other regarding the port.

The indication may therefore contain an address, particularly an IP (Internet Protocol) address, or a logical identifier, such as a URI (“Universal Resource Identifier”) that complies with the SIP protocol.

It may also contain a port number.

The various parts of the indication may be introduced by keywords. By way of example, the keywords “rpathHost” and “rpathPort” may be used to introduce to address-related part and the port-related part, respectively.

In the example of FIG. 2, one possible “Via” header would be:
Via: SIP/2.0/UDP H_{C1}:P_{C3}; branch=z9hG4bKa7c6a8dlze; rpathHost=H_{S1};
rpathPort=P_{S3};

These two parts may contain a reserved word rather than an address identifier or a port number. This reserved word specifies a behavior for the communication server to carry out for choosing the interface (i.e. the address and/or port) to use for sending its reply signaling message.

Such a reserved word may specify that the address or port to use is the same as the one where the server received the message.

It may specify that the address or port to use must be determined randomly.

It may also indicate a semantic criterion for determining the address or port to use.

When the server possesses multiple addresses, it is naturally possible to use such a reserved word for just the address-related part, or for the port-related part, or for both. In the latter case, the reserved words may be identical or different for the address and the port.

Furthermore, the communication client may be designed to insert a second indication regarding the protocol for the server to use for sending its reply signaling message.

This indication may be a protocol identifier. This identifier may be that of one of the transport protocols available: TCP, UDP, etc.

This indication may also be a reserved word rather than a protocol identifier. This reserved word specifies a behavior for the communication server to carry out when choosing the protocol to use for sending its reply signaling message.

Such a reserved word may specify that the protocol to use is the same as the one used for the signaling message M. It may specify that the protocol to be used must be determined randomly. It may also indicate a semantic criterion for determining which protocol to use.

FIGS. 3, 4 and 5 depict diagrams of various behaviors of the server, as specified by the indication. In these examples, the client UAC and the server UAS have only one address, in order to make the explanations clearer.

The notion of an interface is combined, in this case, with the ports. Likewise, the second indication, regarding the transport protocol, is not discussed. However, the explanations must be generalized so as to also apply to a situation in which the server UAS has multiple address, and mutatis mutandis, to the transport protocol.

In all of these examples of FIGS. 3, 4 and 5, the client UAC transmits a signaling message M to the port 5060 of the server UAS. Its IP address is 192.168.0.1

In the situation depicted in FIG. 3, the “Via” header may thereby be:

Via: SIP/2.0/UDP 192.168.0.1:5060; rpathPort=incoming;

The word “incoming” is, in this example, the reserved word specifying that the client UAC is requesting that the server UAS sends it the reply message R from the same port as the one where it received the message M. The server UAS therefore determines the sending port by using this reserved word, and therefore transmits the reply message R from port 5060.

Such behavior may be requested when a NAT (“Network Address Translator”) address translation device or a Firewall is placed between the server UAS and the client UAC. These devices only allow traffic to be transmitted when said traffic corresponds to a determined transaction. Once the transaction has been accepted, the corresponding traffic may traverse the device, but any other message is refused. It is therefore important that the reply signaling message R be considered by the address translation device as belonging to the same transaction as the signaling message M. It is therefore essential that it takes the same path: the same addresses and the same ports.

The reserved word “incoming” is thus used to ensure that the reply message will indeed take the same path, and that it will therefore be able to traverse these types of devices.

In the situation depicted in FIG. 4, the “Via” header may thereby be:

Via: SIP/2.0/UDP 192.168.0.1:5060; rpathPort=any

This reserved word “any” specifies that the client UAC requests that the server UAS randomly determine the port for sending the reply R. In the example, the server UAS randomly chooses port 4567 for sending the reply message R to port 5060 of the client UAC.

This may enable the client UAC to have advance knowledge of the use of a reserved path by the server, such as the one which is secure for IPSEC.

It may also be imagined that other models of server behavior may be requested by a client. For example, it may be imagined that the client may request that the port used by the server is different from the receiving port.

It is also possible that a reserved word indicates a semantic criterion for determining the port to use. This semantic criterion may, for example, be a mechanism requesting a particular port.

Such a mechanism may be IPsec (“Internet Protocol Security”) as defined by RFC 2401. This example is depicted by FIG. 5. One possible “Via” header is:

Via: SIP/2.0/UDP 192.168.0.1:5060; rpathPort=ipsec;

The reserved word may be “IPSEC”, and the server UAS receiving a message M comprising such a reserved word determines which port is associated with this IPsec mechanism, and sends the reply message R from this port, as required by the specifications of the IPSEC protocol.

This example embodiment of the invention resolves a technical problem which has until now has been poorly handled. The known technique consisted of implementing additional software means within the UAS servers (and therefore potentially within any device implementing the SIP protocol) in order to analyze the incoming signaling messages and determine whether the IPSEC mechanism is required. If it is, the server UAS uses the port associated with IPSEC.

This solution therefore requires that software means be added, which creates a burden on the processing of SIP signaling messages.

In this case, the invention makes is possible to bypass these software means, and to only require that the devices are aware of the IPSEC mechanism.

It is also possible to set other reserved words corresponding to other semantic criteria. For example, certain reserved words may correspond to types of traffic (like “VoIP”, “Instant Messaging” . . . ) thereby enabling the data flows to be sorted. Such an embodiment may make it possible to easily perform a control or create statistics regarding the data flows, looking only at the ports. For example, a flow that may become problematic can be interrupted by closing the corresponding port.

Likewise, a second indication makes it possible to specify the transport protocol that must be used by the communication server.

The communication client may therefore be designed to insert into the signaling message this second indication regarding the protocol for the server to use for sending its reply signaling message. The communication server may likewise be designed to determine the protocol to use for sending the reply signaling message, based on this second indication contained within the incoming signaling message.

This second indication may be introduced by a keyword, such as “rpathTransport”, and may consist of a protocol identifier (TCP, UDP, etc.) or a reserved word specifying a behavior for the server to carry out.

These reserved words may be similar to those used for the first indication.

Another reserved word (for example, “nochange”) may indicate that the reply message will be carried by the same protocol as the one used for the initial signaling message. In particular, in situations where this protocol is UDP, the reserved word “nochange” indicates that the UDP transport protocol will be used for the reply message, even if the length of this reply message exceeds the threshold (typically 1300 bytes) above which the transmission of an SIP message normally switches to TCP.

The use of the second indication therefore makes it possible to bypass a default mechanism and to impose a specific behavior.

The invention also makes it possible to resolve the problem of NAT address translation device traversal and/or firewall traversal, in a relevant fashion.

FIG. 6 depicts one embodiment of the invention for these purposes.

An address translation device NAT defines a space or private network, PRI, and a public space PUB.

The devices, A, located within the private network PRI do not strictly speaking have any public addresses. In order to communicate with the public network (or with other private networks, but via the intermediary of the public network), they must transmit their messages through a NAT address translation device. This device dynamically assigns them a public address and makes the necessary changes to the outgoing messages so that the private addresses are replaced by dynamically assigned public addresses.

The NAT device saves a binding between a private address and a public address, in order to be able to route messages arriving from the public network. These messages actually contain only the public address of device A, because the private address is unknown, and holds no meaning outside of the private network PRI. Conversely, this public address, dynamically assigned by the NAT device, does not allow for the message to be routed within the private network PRI. The NAT device uses the saved bindings to perform address translation in reverse, and replace the public addresses with private addresses.

However, these bindings have a temporary value.

Within the TCP (“Transport Control Protocol”), protocol, the binding will be deleted by the NAT device once a certain period of time has passed since the last TCP connection message.

Furthermore, it may be harmful to artificially keep a TCP connection open by transmitting messages for no reason other than to refresh the time-to-expire. In reality, a TCP connection requires resources in each of the parties, and deployment problems arise once a device has to manage a large number of TCP connections.

Generally, the NAT address translation devices also implement a firewall, which forbids TCP connections coming from a device B located within the public area PUB. This device B transmits messages carried by the TCP protocol to a device A located within the private area PRI, but only over the existing TCP connection created on the initiative of device A.

The SIP protocol may be carried by various protocols, as mentioned above, but the TCP protocol has various benefits that make it indispensible for certain applications and certain situations/

A problem therefore arise when the device B wishes to transmit an SIP signaling message carried by the TCP protocol to the device A, without any TCP connection existing beforehand.

For example, this is true when the device B is a “SIP proxy” intermediary signaling element. For example, it may be a P-CSCF (“proxy-Call Session Control Function”) element.

This element receives an invitation message intended for device A. This invitation message is typically a SIP “Invite” message whose purpose is to invite the device to accept a communication session with the sender of the invitation message (not shown in the figure). Assume that this TCP invitation message is carried by the TCP protocol and must be transmitted to the called party using this TCP protocol.

The device B then transmits a signaling message M intended for device A.

In order to traverse the NAT address translation device, it transmits this message M using the UDP (“User Datagram Protocol>>) protocol, which requires no connection.

Within this message, it inserts an indication specifying that the device A must transmit a reply using the TCP protocol as the transport protocol. In one embodiment of the invention, it inserts a “rpathTransport=TCP” parameter into the “Via” header.

The device B, acting as a UAS server, transmits a reply message R to the device A, acting as a UAC client.

This reply message R creates a TCP connection between the two devices.

Once the reply message R has been received, the device B then transmits the previously received invitation message Ml.

This invitation message Ml may be transmitted using the TCP protocol, because the connection has already been opened by the reply message R.

The invention therefore makes it possible to request a reply using a different transport protocol than the protocol used for the original message, which the “Via” header did not allow, because it specifies both the original message protocol and the protocol requested for the reply.

The invention therefore makes it possible to resolve the problem of transmitting a SIP invitation message using TCP to a device located behind a NAT.

1) A communication client, comprising at least one sending interface for sending a signaling message in accordance with the SIP protocol, to a first interface of a communication server, said client and said server being connected to one another via a communication network, and said client configured to insert an indication into the signaling message regarding the interface to be used by said communication server to send a reply signaling message.

2) A communication client according to the preceding claim, wherein said indication contains an address for said communication server to use to send the reply signaling message.

3) A communication client according to claim 1, wherein said indication contains a reserved word specifying a behavior for said communication server to carry out in order to choose which address to use for sending its the reply signaling message.

4) A communication client according to the preceding claim, wherein said reserved word is chosen from a group comprising at least:
a reserved word specifying that said address to be used is the same as that of said first interface;
a reserved word specifying that said address to use must be determined randomly;
a reserved word indicating a semantic criterion for determining said address to use.

5) A communication client according to claim 1, wherein said indication contains a port number for said communication server to use for sending its the reply signaling message.

6) A communication client according to claim 5, wherein said indication contains a reserved word specifying a behavior for said communication server to carry out in order to choose which port number to use for sending the reply signaling message.

7) A communication client according to the preceding claim, wherein said reserved word is chosen from a group comprising at least:
a reserved word specifying that said port number to be used is the same as that of the first interface;
a reserved word specifying that said port number to use must be determined randomly;
a reserved word indicating a semantic criterion for determining said port number to use.

8) A communication client according to claim 1, designed to insert a second indication into the signaling message regarding the protocol to be used by said communication server to send the reply signaling message.

9) A communication system according to claim 1, wherein said indication is inserted into a “Via” header.

10) A communication server comprising at least one interface for receiving an incoming signaling message from a communication network, and a second interface for sending a reply signaling message, and the server configured to determine said second interface based on an indication contained within said incoming signaling message.

11) A communication server according to the preceding claim, wherein said indication contains an address corresponding to said second interface.

12) A communication server according to claim 10, wherein said indication contains a reserved word specifying a behavior to carry out for choosing the address corresponding to said second interface.

13) A communication client according to the preceding claim, wherein said reserved word is chosen from a group comprising at least:
a reserved word specifying that said address is the same as that of said first interface;
a reserved word specifying that said address must be determined randomly;
a reserved word indicating a semantic criterion for determining said address.

14) A communication server according to claim 10, wherein said indication contains a port number corresponding to said second interface.

15) A communication server according to claim 14, wherein said indication contains a reserved word specifying a behavior to carry out for choosing the port number corresponding to said second interface.

16) A communication client according to the preceding claim, wherein said reserved word is chosen from a group comprising at least:
a reserved word specifying that said port number is the same as that of the first interface;
a reserved word specifying that said port number must be determined randomly;
a reserved word indicating a semantic criterion for determining the port number.

17) A communication server according to claim 10, designed to determine the protocol to use for sending said reply signaling message, based on a second indication contained within said incoming signaling message.

18) A communication system according to claim 10, wherein said indication is inserted into a “Via” header.

19) A method for communicating signaling messages between a client and a server connected to one another by a communication network, comprising:
transmitting a signaling message to said server; and
receiving, at said client, a reply message: from said client, and wherein
said client inserts an indication within said signaling message prior to said transmitting, and said indication indicates an interface based on for a server to send said reply message.

20) A communication terminal designed to implement a communication client according to claim 1.

21) A communication terminal designed to implement a communication server according to claim 10.

22) A communication network comprising at least one terminal according to claim 20,

23) A communication device configured so that when the communication device receives an incoming signaling message carried by the TCP protocol and intended for a second communication device located behind an address translation device, the communication device transmits to said second device a signaling message using the UDP protocol and containing an indication regarding the interface for said second device to be used to send a reply to said communication device, and to transmit said incoming signaling message after receiving said reply message, said indication specifying that said reply must use the TCP protocol.

24) A communication system containing a communication device in accordance with the preceding claim, wherein said second device is a server according to claims 17.

25) A communication system according to the preceding claim, wherein said indication is inserted into a “Via” header.
